(19) United States
(12) Patent Application Publication
(10) Pub. No.: US 2023/0248142 A1
(43) Pub. Date: Aug. 10, 2023

(54) OUTDOOR CABINET APPARATUS AND METHOD

(71) Applicant: Scott C. Lunt, Helotes, TX (US)

(72) Inventor: Scott C. Lunt, Helotes, TX (US)

(21) Appl. No.: 17/668,451

(22) Filed: Feb. 10, 2022

(51) Int. Cl. A47B 77/02; E04C 2/04; A47B 87/00

(52) U.S. Cl. CPC A47B 77/02; E04C 2/04; A47B 87/005; A47B 2077/027

(57) ABSTRACT

An outdoor cabinet kit, comprising a first planar front or rear base cabinet panel made of lightweight reinforced thin cement based composite material having interlocking side tabs and notches on first and second vertical edges so multiple front and rear are connected together to make a kitchen base cabinet. Two second planar side base cabinet panels made of lightweight reinforced thin cement based composite material having side tabs and notches on third and fourth vertical edges meshing with the interlocking tabs and notches of the first planar front or rear base cabinet. Thin set or adhesive filler adheres the panels together. Reinforcing upper or lower cross beams made of lightweight reinforced cement based composite material inserts in notches in the first planar front or rear base cabinet panels to provide reinforcing. Thin set or adhesive filler adheres the panels together.

### CROSS-REFERENCE TO RELATED APPLICATIONS

N/A

### STATEMENTS REGARDING FEDERALLY SPONSORED RESEARCH OR DEVELOPMENT

N/A

### REFERENCE TO A MICROFICHE APPENDIX

N/A

### BACKGROUND OF THE INVENTION

### 1. Field of the Invention

The invention relates to outdoor kitchens, islands and bars and in particular to an apparatus and method for construction outdoor base cabinets from prefabricated, interconnecting, light-weight thin cement based composite panels and components that can be quickly assembled on site.

### 2. Description of the Related Art

Outdoor kitchens have become very popular at homes. In the past these have typically been of masonry construction using concrete blocks and bricks for their durability and appearance. This requires substantial labor and time to deliver materials and assemble at the kitchen location. They can also be made of all metal construction typically of stainless steel to provide weather resistance. Some outdoor kitchens include a metal framework to reinforce and support the components and cement boards attached to the metal framework.

A modular outdoor kitchen is disclosed in published patent application No. US 2004/0065313, filed May 14, 2003, published Apr. 8, 2004, Arthur Charles Thompson, inventor. It includes a modular outdoor kitchen comprises a plurality of weather resistant outdoor kitchen modules. Each module comprises a frame having a plurality of outer faces. The modules are releasably connected together in mating arrangement. A plurality of weather-resistant fascia panels are provided on at least a portion of the pluralities of outer faces of the frames with an exterior surface that simulates the appearance of an outdoor building material.

Another modular outdoor kitchen is disclosed in published patent application US 2005/0246969, filed Jul. 28, 2003, published Nov. 10, 2005, Anthony Jarski, inventor. It includes a component modular outdoor kitchen assembly, which has cutouts for a-B-Q grill, a refrigerator, doors, grills and miscellaneous inserts. It consists of five basic panels, or two modular units, arranges into different configurations, made solely of cementatious materials and bonded with a waterproof mastic. Panels are approximately one and one quarter inch thick, with a height of approximately thirty-six inches. The interior framework of the panels are three-quarter by two inches, and three quarter by four inches, for Structural purposes. The assembly of the modular units consists of stainless-steel clips and pins in corners, acting as the only necessary assembly, giving the component modular outdoor kitchen a claimed minimal set-up and break-down time, approximately five minute per unit.

Another outdoor kitchen system is disclosed in published patent application US 2010/0148641, filed Jun. 5, 2009, published Jun. 1, 2010, Robert Ehmke, inventor. The modular system which includes standard components for constructing a customized easily leveled modular kitchen system which can be installed and used in non-traditional kitchens. Various embodiments may also include infinite configurations of panels, counter rails, adjustable arms, tracks and frame connectors, as well as structural configurations to facilitate attachment of weather-stripping material. These configurations for attaching and minimizing the appearance of weather stripping may include grooves, notches, apertures and protuberances.

Another outdoor kitchen system is disclosed in U.S. Pat. No. 8,147,009, filed Dec. 1, 2009, and issued Apr. 3, 2012, to H. Joe Rider. It discloses a component system for constructing the framework for cabinets used for building an outdoor kitchen. The components system consists of specially designed brackets used in conjunction with lightweight concrete side end panels to construct the forms for the cabinets. The brackets have channels that attach to the corner edges of the concrete side end panels and hold the side end panels in place so that the top edges of the panels are accessible for attachment of back splashes and back bars. Brackets with more than one channel have support rods connecting their channels and holding them in spaced apart arrangement. Once the forms are constructed, their exterior surfaces can be finished in a variety of ways. The counter tops, wiring, plumbing, appliances and doors for the cabinets can then be installed to complete the cabinets and kitchen.

Another outdoor kitchen is by Walt tools, www.walttools.com, using a modular precast panel system. It makes panels from concrete that are secured together to form interlocking panels that are 32″ tall and 4″ deep and made using a poly-concrete hybrid design and weigh a fraction of solid concrete. Panels interlock both in linear and perpendicular fashion. Panels include interlocking tabs on each side with holes extending through the tabs for receiving locking pin or bars. The manufacturing of the panel is disclosed in the video at https://www.walttools.com/resources/diy-outdoor-kitchen-class-with-concrete-countertop-solutions/.

Stone Age Manufacturing, https://stoneagemanufacturing.com/, markets an outdoor kitchen and claims its “lightweight, glass fiber reinforced concrete panel and galvanized steel bracket system creates infinitely configurable kitchen island layouts that assemble in minutes, yet deliver strength and durability far superior to other construction methods, providing a strong, stable foundation for appliances and kitchen equipment, that may be covered with any masonry-compatible finish.” The panels can be adhered to each other end to end and rely on metal brackets. “Kits consist of 2” thick lightweight concrete panels of varying width, that are glued together using landscape block adhesive and galvanized steel brackets that further bond the panels for additional security. Upper brackets assist in easily maintaining a uniform depth and keeping the cabinets square during assembly.” “Adhesive beads” are used to secure panels and the metal brackets to each other.

Concrete Components, https://concretecomponents.com/index.html, markets Stone Kitchen Modular Outdoor kitchens. The kitchens are made of precast concrete interlocking components including vertical posts that have vertical longitudinal notches that hold panel components in place. The components are made of solid reinforced concrete blended with certain admixtures and reprocessed Styrofoam for weight reduction. The outer surface of the panels may be embossed to simulate stone. The vertical posts and panels are bonded together with TypeN mortar.

### BRIEF SUMMARY OF THE INVENTION

The invention comprises an outdoor cabinet of varying sizes and configurations made from only combinations of two light weight thin cement based composite panels, cross beams and backsplash units and thin set or other similar adhesive. The panels have interlocking edges and interlock and fit together and are held together by thin set or other similar adhesive. The cross beams can be added to the upper edge to support a kitchen countertop and lower edges of the panels where needed. Back splash units may be added to the upper edges of the rear panel to support a countertop. Holes are cut into the panels and countertops to accommodate metal outdoor cabinet inserts, drawer inserts, refrigerators, cooking grills and the like. A decorative finish such as plaster, tile, brick or other weather resistance decorative finish is typically provided for the outside of the cabinets. The use of only four prefabricated components allow various size and configured cabinets to be quickly assembled on site with substantial saving in time and labor.

The advantages of the invention include speed of construction, impervious to weather, full masonry construction, customizable to different standard sizes and shapes.

An advantage of having a different side end panel is that is does not leave notches at the top or bottom and at mid top which are used by the cross beams. Also it makes it easier for panels to fit better at sides. The configuration of the front and rear panels make its section 30 inches wide.

The cross beams that interlock with the panels allow the panels to be thinner so they weigh less for transport and are easier to handle and move during installation. The countertops that are concrete or stone are heavy and the wide crossbeams support the countertops and give them a solid feel. The cross beams maintain the 30 inch width when they are in place and panels are abutted together end to end. The cross beams keep the structure in line and true vertical during construction until the thin set fully hardens.

The configuration of the panels and cross beams allow one to construct an outdoor kitchen in a matter of an hour with thin set. The kitchen can be customized to many shapes and configurations.

The cabinets are a full masonry product that be quickly constructed, does not rust, and is usable near bodies of salt water.

### BRIEF DESCRIPTION OF THE SEVERAL VIEWS OF THE DRAWINGS

FIG. 1 is an elevation view of the four components used to construct the outdoor cabinet.

FIG. 2 is an elevation view of the planar front and rear base cabinet panel.

FIG. 3 is an elevation view of the planar side end base cabinet panel.

FIG. 4 is a perspective view of the reinforcing cross beam.

FIG. 5 is a perspective view of the backsplash member.

FIG. 6 is a side elevation view of the backsplash member.

FIG. 7 is a perspective view of an example of base cabinets under construction.

FIG. 8 is a perspective view of an example of base cabinets under construction.

FIG. 9 is a perspective view of an example of base cabinets under construction.

FIG. 10 is a perspective view of an example of base cabinets under construction.

FIG. 11 is a perspective view of an example of finished base cabinets with kitchen components added.

FIG. 12 is a perspective view of an example of finished base cabinets with kitchen components added.

### DETAILED DESCRIPTION OF THE INVENTION

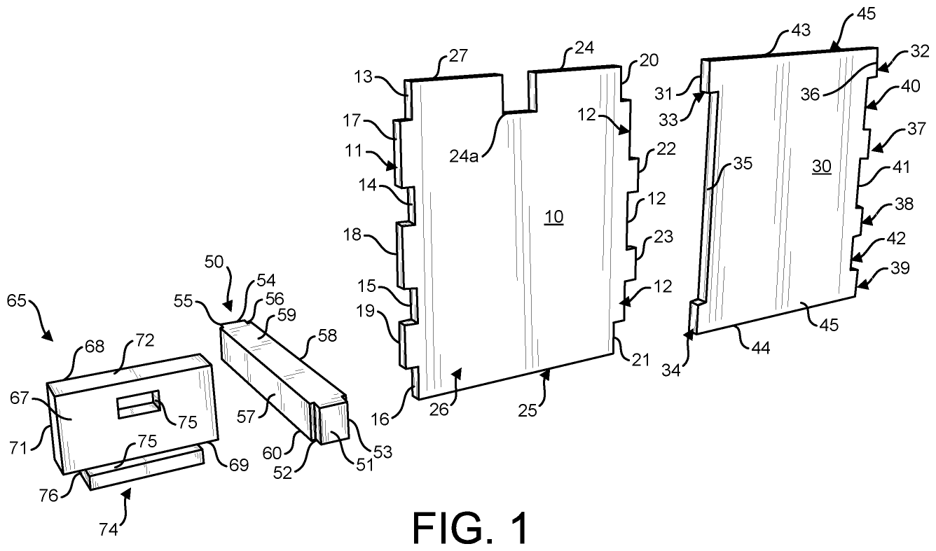

Referring to FIGS. 1-5 there is shown the components used to construct prefabricated outdoor kitchen base cabinets and islands and bars from light weight thin cement based composite panels. The components are mass manufactured in a fabrication plant and transported to the construction site where they can be quickly connected to form base cabinets using only thin set or other adhesive and filler to secure the components and fill in any joints or openings. A standard weather resistant countertop is mounted on the cabinets and any backsplash after construction. The outer surface of the cabinets can be finished or decorated as desired. This could include a masonry surface finish such as stucco and could be painted. The panels are easily cut with a masonry saw and drilled with a masonry bit to form openings and cut outs for metal or stainless steel cabinet inserts, drawer inserts, outdoor refrigerators, ice makers, cooking grills, burners and other components. The outdoor kitchen components may be stainless steel to be weather resistant. The outdoor kitchen components are standard and have been available for many years for outdoor masonry kitchens.

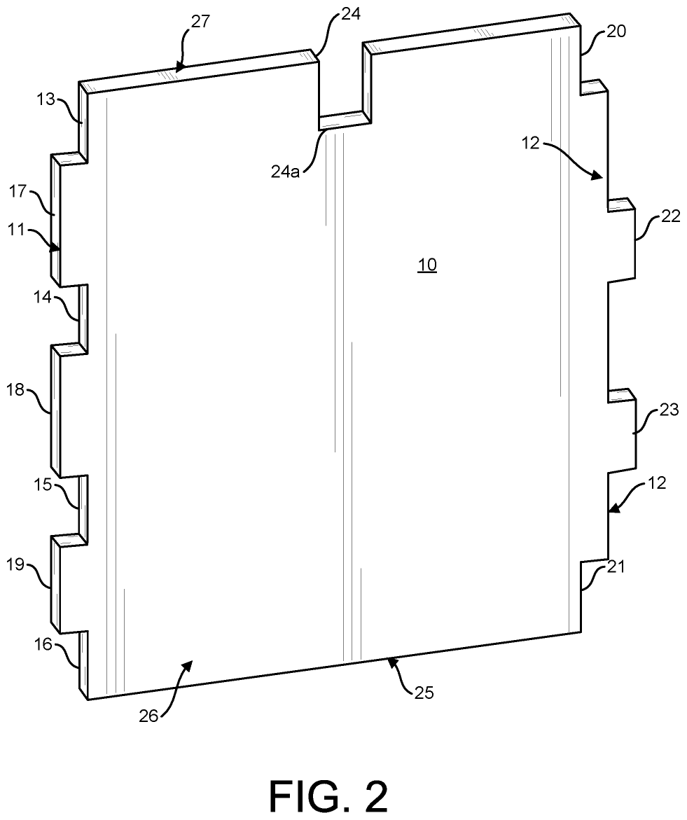

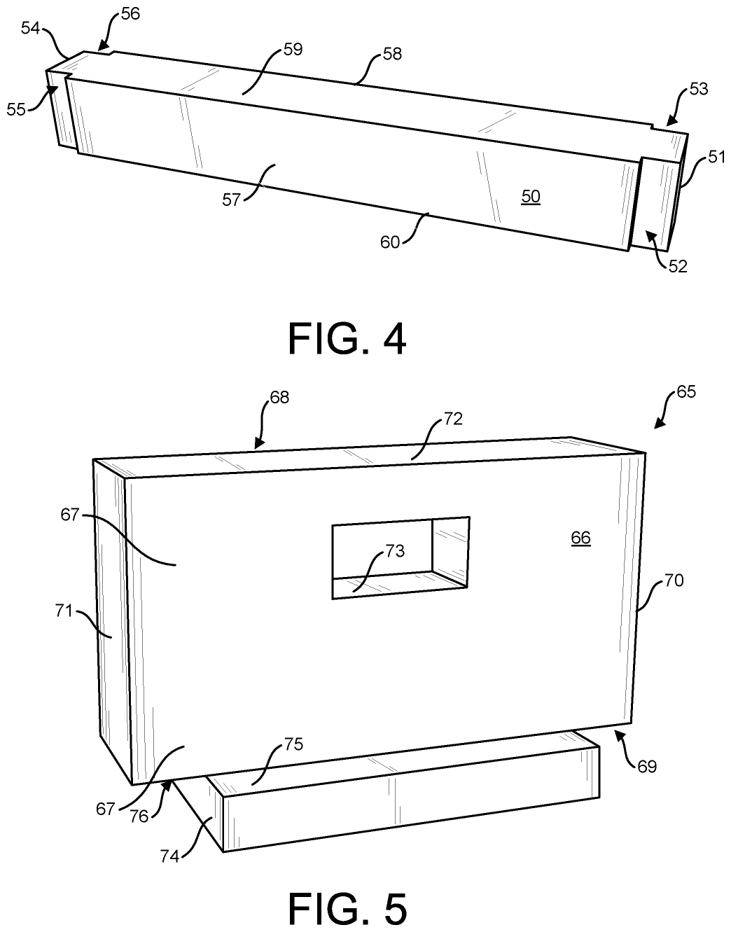

Referring to FIGS. 1 and 2, there is shown a planar base cabinet panel 10. The cabinet panel 10 includes a vertical side 11 and an opposing vertical side 12. The vertical side 11 includes cut-out notches 13, 14, and 15, and 16. It also includes tab 17, 18 and 19. The opposed vertical side 12 includes cutout notches 20 and 21. The opposed vertical side 12 also includes tabs or teeth 22 and 23. The panel includes an upper flat edge 24 and opposed bottom ledge 25. A three-inch square notch or cut out 24a is provided in the upper flat edge to receive the tabs or teeth 51 and 54 of cross beams 50 shown in FIG. 4. The panel includes a front side 26 and an opposed rear side 27. The notches or cut outs 16 and 21 when next to each other after assembly form a three-inch square notch or cut out to receive the tab 51 on the cross beam 50.

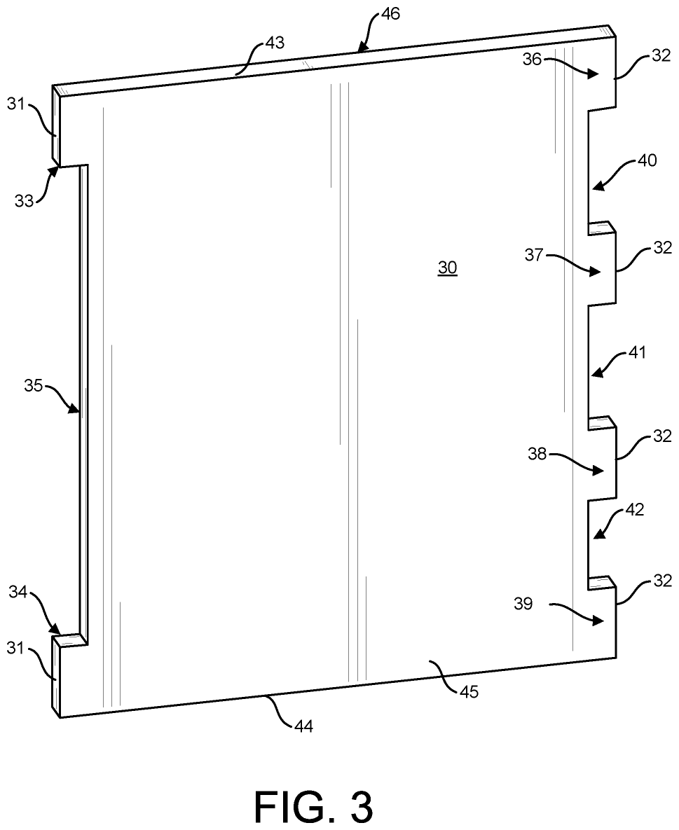

Referring again, to FIGS. 1 and 3, there is shown a second planar base cabinet panel 30. The cabinet panel 30 includes a third generally vertical side 31. The second cabinet panel includes a fourth opposing vertical side 32. The third vertical side 31 includes a large, elongated notch or cutout 35. The vertical edge 31 includes an upper tab 33 and a lower tab 34. The opposed fourth vertical side 32 includes tabs or teeth 36, 37, 38, and 39. It also includes notches or cut outs 40, 41, and 42. The panel includes an upper edge 43 and opposed lower edge 44. A first side 45 is provided, and a second back side 46 is provided.

As shown in FIGS. 1 and 4, a reenforcing crossbeam 50 is shown. The cross beam may be made of light weight cement based composite material or other suitable material that is strong enough to support a countertop and connect between opposed panels 10 on the cabinet fronts and backs The crossbeam 50 includes a tab 51, having notches or cutouts 55 and 56 on each side. The crossbeam includes a first side 57 and an opposed side 58. It provides an upper support surface 59 and a lower opposed surface 60. The other end includes a tab 54, having notches or cutouts 55 and 56.

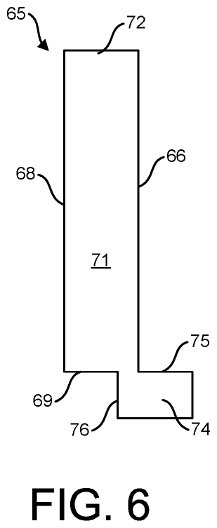

As shown in FIGS. 1 and 5, a backsplash component made of light weight cement based composite material or other suitable material is provided for mounting on the upper edge of one of the panels 45 with the upper rear edge 43 of the panel 30. The rectangular backsplash 65 includes a rectangular backsplash panel 66 That is about four inches thick having a front planar surface 67 and a rear planar surface 68. It includes a lower edge 69 as best shown in FIG. 6 and side edges 70 and 71. The lower edge 69 sit on top of upper edge 24 of panel 19. It includes a rectangular electrical receptacle box cutout 73 for receiving an electrical box for inserting an electrical plug. It includes a rectangular countertop support tab 74, as also shown in FIG. 6, that includes in a countertop resting surface 75. The back support tab surface 76 engages the wall 27 of the panel 10.

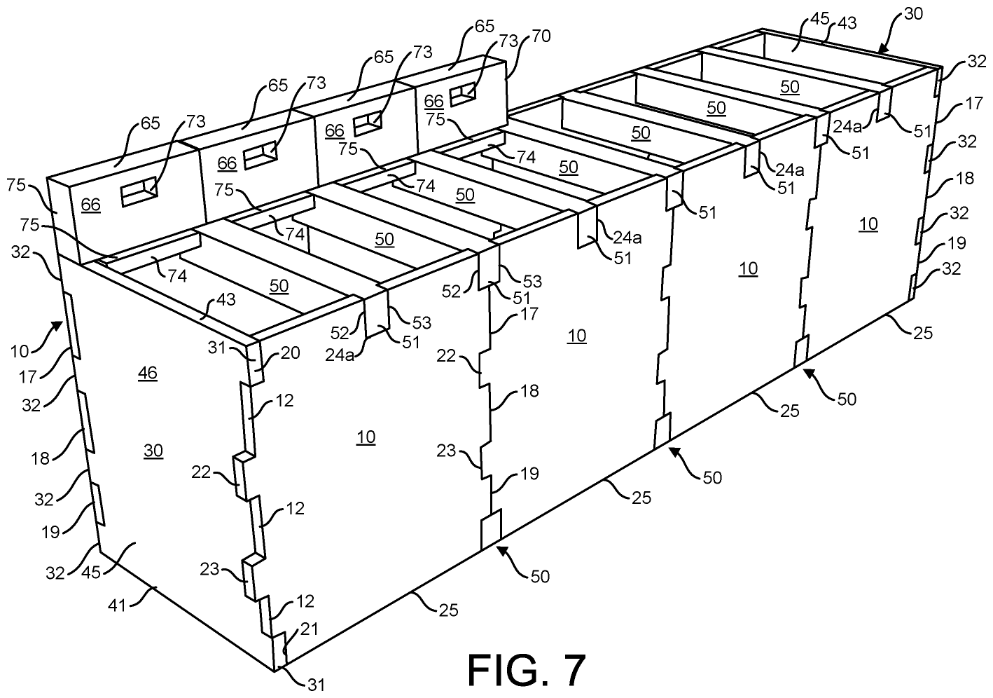

FIG. 7 shows a base cabinet during construction. A portion of the back wall formed from panels 10 include backsplash panels 65. Polymer enriched thin set or other adhesive fillers are used to adhere the parts together and make the cabinet rigid. The thin set or adhesive could also fill any cracks where the components are joined together. At this point the joints are at least partial visit without any finish on the outer surfaces of the panel. The panels 10 on the back run the opposite direction as the panels on the front. The different edge configurations 31 and 32 on side end panels 30 allows it to be places at either side by flipping its side edges. The tabs or teeth 23 and 23 are cut off with a masonry saw. Cross beams 50 are shown in all of the notches formed on the upper edges of the front and rear panels. However, upper cross beams may be left off in areas where a kitchen component such as a grill is installed where the cross beams would be. Similarly a lower cross beam may be left out when a kitchen component such as a refrigerator is installed. Any notches not filled with a cross beam would be filled in with thin set or similar filler. Openings may be cut out in the front panels 10 to accommodate cabinet components such as metal cabinet inserts, metal drawer inserts, metal door inserts, cooking grills, refrigerators, wine coolers and icemakers. Components such as sinks, and faucets can me mounted in countertops that are added to the finished cabinets. Suitable electrical wiring and plumbing can be positioned inside the cabinet. Each of the backsplash panels 50 includes a rectangular electrical box cut out 73. Any unused cut outs 73 would be filled with thin set during assembly of the panels.

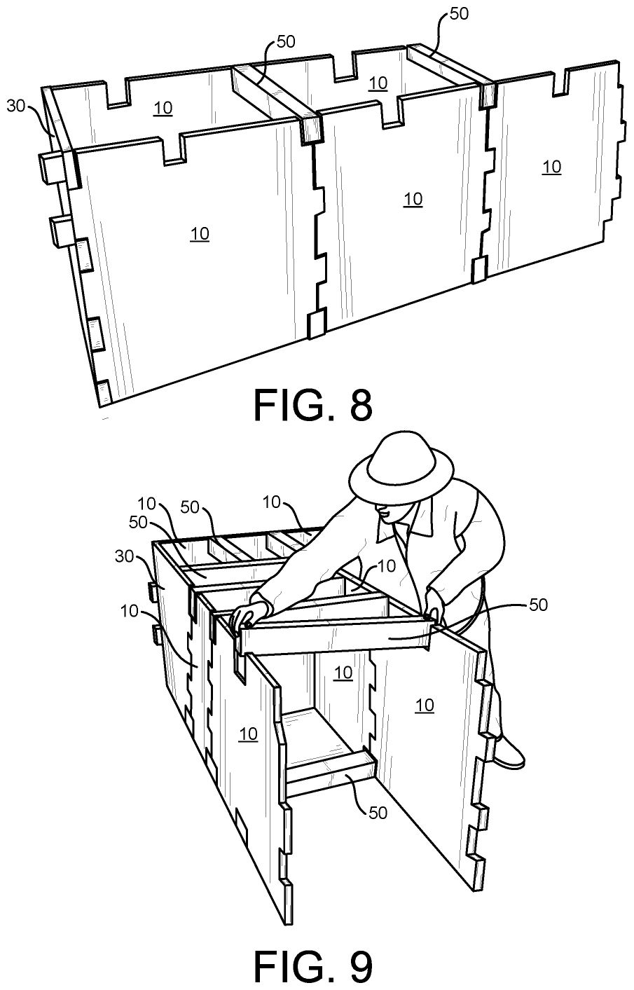

FIG. 8 shows the rear of a base cabinet during construction. This illustrates the flipping of the panel sides for the rear cabinet assembly during installation. FIG. 9 shows an installer placing the components in position during assembly of an “L” shaped kitchen. This is two separate cabinets that are abutted against each other.

Polymer enriched thin set or other adhesive filler is placed in all joints to adhere the components together and form a rigid cabinet. The thin set would fill any empty notches and gaps in the interconnected tabs or teeth and notches and would be troweled smooth with the outer surfaces of the panels.

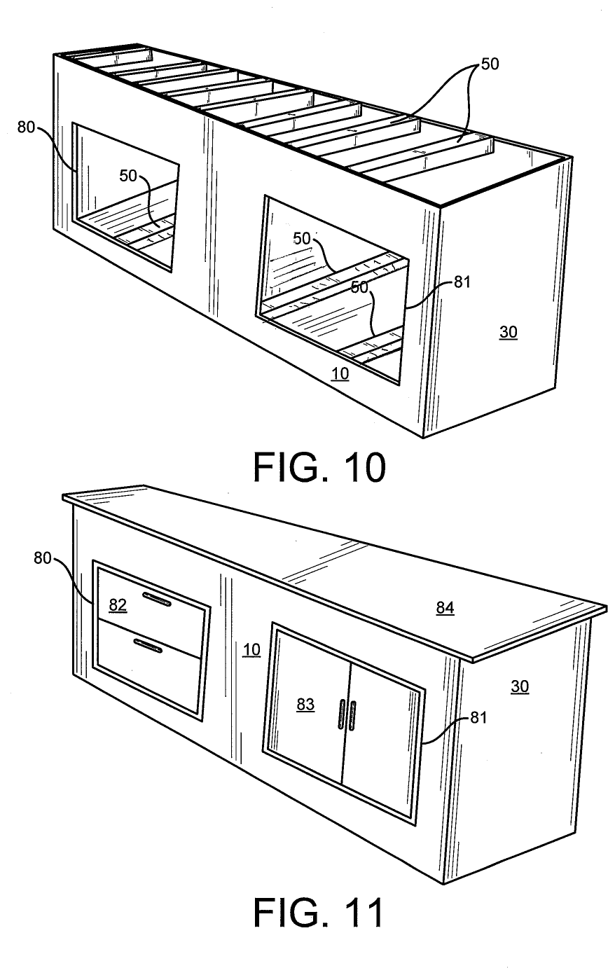

FIG. 10 shows a finished cabinet without any countertop and kitchen components installed or any backsplash. A decorative finish such as plaster, tile, brick or other weather resistant decorative finish is typically provided for the outside of the cabinets. The cabinets include openings 80 and 81 cut into the front panels 10 with a masonry saw for receiving metal kitchen components. The connection lines are no longer visible with an outer surface finish such as plaster or stucco that is troweled onto the outer surface to give it a finished look.

FIG. 11 shows a finished cabinet with a decorative finish and with a countertop 84 and kitchen components 82 and 83 installed without any backsplash. The cabinets openings 80 and 81 in the front panels 10 have metal kitchen components such as drawer unit 82 mounted in opening 80 and door cabinet unit 83 mounted in opening 81. The connection lines are hidden by an outer surface finish such as plaster or stucco that is troweled onto the outer surface to give it a finished look.

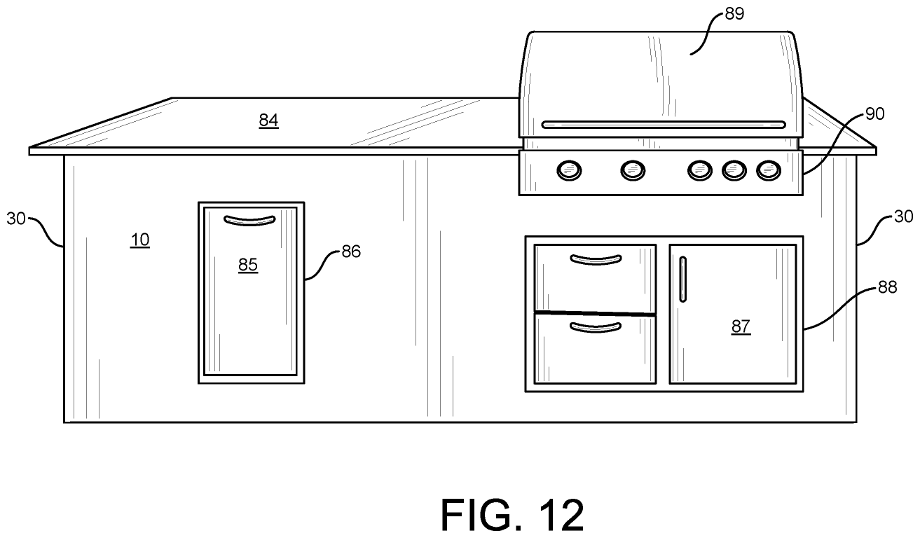

FIG. 12 shows a finished cabinet with a decorative finish with a countertop 84 and kitchen components 82 and 83 installed without any backsplash. The cabinet openings 86 and 88 in the front panels 10 have metal kitchen components such as refrigerator 85 mounted in opening 86 and drawer and door cabinet combination unit 87 mounted in opening 88. A cooking grill 89 is mounted cutouts in the countertop 84 and front panel. A natural gas line and electric connection for the grill may be mounted inside the cabinet. An access door may be mounted in the end or rear of the cabinet for placing an LP gas tank inside the cabinet to power the cooking grill 89. The connection lines are hidden by an outer surface finish such as Stucco Stone, or Tile, that is troweled onto the outer surface to give it a finished look.

The panels, backsplash, and cross beams are made of a lightweight, fiber reinforced, thin cement-based composite. Materials used include Portland cement, sand, and fired clay gravel. Shredded fiberglass or other suitable lightweight reinforcement is added to the mix to act as a strengthener and helps prevent cracking from shrinkage, and transport. Dry polymer is also added to the mix to improve adhesion, flexural strength, tensile strength, and freeze/thaw durability. It also reduces permeability, the intrusion of chlorides, salts, and carbon dioxide. Cement hardener is included to increase compression strength. An example is Nyad G which reacts with the crystalline structure of cement to make it hard. Fly ash is added to decrease curing time and increase heat tolerance. Calcium Sulfate Aluminate or CSA may be added primarily for high heat refractory applications, moderate acid-resistance, high-early-strength and quick-setting mixtures, and as part of the expansive component in shrinkage-compensating cements. Cement hardener increases compression strength of panels. Fired clay gravel is lighter, harder, and thermally stable. The added curing agent decreases curing time and increases heat tolerance.

The panels are cast in molds. Each mold has a rigid outer mold of plastic material and an inner flexible mold. The rigid outer mold keeps the shape of the panels flat without bowing or sagging and the inner mold allows the mold to flex and release from the panel after curing. The notches for the beam are about three inches square in cross section. You may fill in unused beam notches with a block and thin set Each panel is thirty inches wide and thirty-five inches high and one and one-half inches thick. The height with an added countertop is designed to approximate the standard kitchen cabinet height. When a “L” or other shaped cabinet is desired one simply builds two cabinets and abuts them against each other as shown in FIG. 9.

The above-listed sections and included information are not exhaustive and are only exemplary of the invention. The sections and included information in an embodiment may depend upon the implementation and the included devices and resources. Although a system and method according to the present invention have been described relating to the preferred embodiment, it is not intended to be limited to the specific form set forth herein, but, on the contrary, it is intended to cover such alternatives, modifications, and equivalents, as can be reasonably included within the spirit and scope of the invention as defined by the appended claims

We claim:

1. An outdoor cabinet kit, comprising:
One or more first planar front cabinet base panels and rear cabinet panels made of lightweight reinforced thin cement based composite material having interlocking tabs and notches on a first vertical side edge and mating interlocking tabs and notches on an opposed second vertical side edge such that a base cabinet can have one or more front and rear panels connected together with the interlocking tabs on the first vertical side edge meshing with interlocking tabs and notches on the opposed second vertical side edge of another base cabinet panel;
Said first planar front and rear base cabinet panels having a lower edge and an upper edge with a notch in the upper edge;
Two second planar side end base cabinet panels made of lightweight reinforced thin cement based composite material having interlocking tabs and notches on a third vertical side edge and on a fourth vertical side edge with interlocking tabs on the third vertical front side meshing with the interlocking tabs and notches on the second vertical side of the first planar front or rear base cabinet panel and with the interlocking tabs on the fourth vertical rear side of the side panel meshing with the interlocking tabs and notches on the first vertical side of the first planar front or rear base cabinet panel so the panels can form a cabinet;
Said second planar side base cabinet panels having a lower edge and an upper edge and notches in the sides at the lower edges;
One or more cross beams made of lightweight reinforced cement based composite material for mounting in the notches in the panels to connect and reinforce the front and rear base cabinet panels.

2. The outdoor cabinet kit of claim 1, comprising:
The second planar side end base cabinet panels having upper and lower tabs to fill in notches in the first planar front cabinet base panels and rear cabinet panels.

3. The outdoor cabinet kit of claim 1, comprising:
interlocking tabs and notches on the third vertical side edge and on the fourth vertical side edge with interlocking tabs at the upper and lower edges with a notch in between for meshing with the second vertical side of the first planar front or rear base cabinet panel so the panels can form a cabinet.

4. The outdoor cabinet kit of claim 1, comprising:
first planar front base cabinet panels and planar rear base cabinet panels forming notches at the connection edges of the panels to receive cross beams in the notches.

5. The outdoor cabinet kit of claim 1, comprising:
The first planar front and rear base cabinet panels having notches formed in the upper edges of adjacent front and rear base cabinet panels;
and a reinforcing cross beam made of lightweight reinforced cement based composite material that inserts in notches in the adjoining base cabinet panels.

6. The outdoor cabinet kit of claim 1, comprising:
The first planar front and rear base cabinet panels having notches formed in the upper edges of adjacent front and rear base cabinet panels and between connected front and rear base cabinet panels;
and reinforcing cross beams made of lightweight reinforced cement based composite material that insert in notches in the upper panels and insert in notches at the upper and lower edges of adjoining base cabinet panels.

7. The outdoor cabinet kit of claim 1, comprising:
A backsplash panel member made of lightweight reinforced cement based composite material for fitting on rear base cabinet panels and having a vertical backsplash section and a horizonal backsplash countertop supporting section for securing to the upper edge of a rear base cabinet panel.

8. The outdoor cabinet kit of claim 1, comprising:
A kitchen countertop made of countertop suitable material for resting on the upper edges of the cabinet panels and cross beams.

9. The outdoor cabinet kit of claim 1, comprising:
Adhering material for securing the panels and cross beams together.

10. An outdoor cabinet kit, comprising:
One or more first planar front and rear base cabinet panels made of lightweight reinforced thin cement based composite material having interlocking tabs on a first vertical side edge and mating interlocking tabs on an opposed second vertical side edge such that a base cabinet can be formed with multiple front and rear panels connected and adhered together at the installation location of the kitchen base cabinet with the interlocking tabs on the first vertical side edge meshing capable of meshing with the interlocking tabs on the opposed second vertical side edge of another base cabinet panel;
Said first planar side base cabinet panel have a lower edge and an upper edge and notches in the sides at the lower edges;
Two second planar side end base cabinet panels made of lightweight reinforced thin cement based composite material having interlocking tabs on a third vertical side edge and on a fourth vertical side edge with the interlocking tabs on the third vertical front side meshing with the interlocking tabs on the second vertical side of the first planar front or rear base cabinet panel and with the interlocking tabs on the fourth vertical rear side of the side panel meshing with the interlocking tabs on the first vertical side of the first planar front or rear base cabinet panel;
One or more cross beams made of lightweight reinforced cement based composite material that inserts in notches in the first planar front and rear base cabinet panels;
A backsplash panel member made of lightweight reinforced cement based composite material for fitting on rear base cabinet panels and having a vertical backsplash section and a horizontal backsplash supporting section for securing to the upper edge of a rear base cabinet panel.

11. A method of constructing an outdoor cabinet, comprising the steps of:
Connecting and adhering one or more first planar front and rear base cabinet panels made of lightweight reinforced thin cement based composite material having interlocking tabs on a first vertical side edge and mating interlocking tabs on an opposed second vertical side edge with another first planar front or rear base cabinet panel made of lightweight reinforced thin cement based composite material such that a base cabinet front or rear is formed with multiple front and rear panels connected together with the interlocking tabs and notches on the first vertical side edge meshing with the interlocking tabs and notches on the opposed second vertical side edge of another base cabinet panel;
Connecting and adhering two second planar side end base cabinet panels made of lightweight reinforced thin cement based composite material having interlocking tabs on a third vertical side edge and on a fourth vertical side edge with the interlocking tabs and notches on the third vertical front side meshing with the interlocking tabs on the first vertical side of the first planar front or rear base cabinet panel and with the interlocking tabs on the fourth vertical rear side of the side panel meshing with the interlocking tabs on the second vertical side of the first planar front or rear base cabinet panel;
Connecting and adhering one or more cross beams to notches in the front and rear base cabinet panels and notches in the sides at the lower edges.

12. The outdoor cabinet assembly method of claim 11, comprising the steps of:
The step of connecting the crossbeam includes connecting a reinforcing upper cross beam made of lightweight reinforced cement based composite material to the top edges of front and rear base cabinet panels.

13. The outdoor cabinet assembly method of claim 11, comprising the steps of:
The step of connecting the crossbeam includes connecting a reinforcing lower cross beam made of lightweight reinforced cement based composite material in notches in the top and lower edges of front and rear base cabinet panels.

14. The outdoor cabinet assembly method of claim 11, comprising the steps of:
The step of connecting the crossbeam includes connecting a reinforcing upper and lower cross beam made of lightweight reinforced cement based composite material that inserts in notches in the upper and lower edges at the joints of adjacent front and rear base cabinet panels.

15. The outdoor cabinet assembly method of claim 11, comprising the steps of:
Connecting a backsplash panel member made of lightweight reinforced cement based composite material on rear base cabinet panels and having a vertical backsplash section and a horizontal backsplash supporting section for securing to the upper edge of a rear base cabinet panel.

16. The outdoor cabinet assembly method of claim 11, comprising the steps of:
Connecting a kitchen countertop made of countertop suitable material for resting on the upper edges of the cabinet panels.

17. The outdoor cabinet assembly method of claim 11, comprising the steps of:
Connecting and adhering two or more first planar front and rear base cabinet panels made of lightweight reinforced thin cement based composite material to form a larger cabinet.

18. The outdoor cabinet assembly method of claim 11, comprising the steps of:
Adhering the joints of panels and cross beam together with adhering material.

19. The outdoor cabinet assembly method of claim 11 comprising the steps of:
Installing kitchen components in openings cut in the front panels.

20. A method of constructing an outdoor cabinet, comprising the steps of:
Connecting and adhering one or more first planar front and rear base cabinet panels made of lightweight reinforced thin cement based composite material having interlocking tabs on a first vertical side edge and mating interlocking tabs on an opposed second vertical side edge with another first planar front or rear base cabinet panel made of lightweight reinforce thin cement based composite material such that a base cabinet front or rear is formed with multiple front and rear panels connected together with the interlocking tabs and notches on the first vertical side edge meshing with the interlocking tabs and notches on the opposed second vertical side edge of another base cabinet panel;
Connecting and adhering two second planar side end base cabinet panels made of lightweight reinforced thin cement based composite material having interlocking tabs on a third vertical side edge and on a fourth vertical side edge with the interlocking tabs and notches on the third vertical front side meshing with the interlocking tabs on the second vertical side of the first planar front or rear base cabinet panel and with the interlocking tabs on the fourth vertical rear side of the side panel meshing with the interlocking tabs on the first vertical side of the first planar front or rear base cabinet panel;
Connecting and adhering one or more reinforcing upper and lower cross beams made of lightweight reinforced cement based composite material that inserts in notches in the first planar front and rear base cabinet panels;
Connecting a backsplash panel member made of lightweight reinforced cement based composite material on rear base cabinet panels and having a vertical backsplash section and a horizonal backsplash supporting section for securing to the upper edge of a rear base cabinet panel;
Connecting a kitchen countertop made of countertop suitable material for resting on the upper edges of the cabinet panels and backsplash panel member horizontal supporting section;
Adhering the panels, cross beams and backsplash panels together with adhering material.
